(19) United States
(12) Patent Application Publication
(10) Pub. No.: US 2009/0119583 A1
(43) Pub. Date: May 7, 2009

(54) IMAGE DISPLAYING APPARATUS, IMAGE DISPLAY METHOD, AND IMAGE DISPLAY SYSTEM

(76) Inventors: Yuka Kihara, Kanagawa (JP); Koji Kobayashi, Kanagawa (JP); Hiroyuki Sakuyama, Tokyo (JP); Junichi Hara, Kanagawa (JP); Taku Kodama, Kanagawa (JP); Maiko Takenaka, Kanagawa (JP); Hirohisa Inamoto, Kanagawa (JP); Tamon Sadasue, Tokyo (JP); Chihiro Hamatani, Tokyo (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/241,208

(22) Filed: Sep. 30, 2008

(30) Foreign Application Priority Data
Nov. 5, 2007 (JP) 2007-287456

(51) Int. Cl. G06F 17/00

(52) U.S. Cl. 715/273

(57) ABSTRACT

An attribute determining unit determines an attribute of image data of an image. A still-image extracting unit extracts, when the attribute is a moving image, a still image from the image data. A feature-amount obtaining unit obtains a feature amount from image data of the still image and image data of a still image when the attribute is the still image. An arrangement-position determining unit determines an arrangement position of a display area based on the feature amount. A display-image generating unit generates a thumbnail image from the still image and displays a list of thumbnail images in the display area, based on the arrangement position and the display area.

### CROSS-REFERENCE TO RELATED APPLICATIONS

The present application claims priority to and incorporates by reference the entire contents of Japanese priority document 2007-287456 filed in Japan on Nov. 5, 2007.

### BACKGROUND OF THE INVENTION

1. Field of the Invention

The present invention relates to an image displaying apparatus, an image display method, and an image display system for visually supporting a search of image data.

2. Description of the Related Art

When searching desired image data out of a large amount of image data saved in a personal computer or the like, based on visual information, it is not efficient for a user to search the image data by viewing while displaying the image data one by one on a screen. Thus, a thumbnail list display in which images are reduced and list-displayed on one screen is known. The thumbnail is, in a case of a still image, a representative image reduced in size by thinning-out the number of pixels. When a plurality of thumbnails is displayed on a single screen, the user can efficiently recognize what images are present.

As a display method so devised that at a time of displaying thumbnails, a content of thumbnail display is given to a user in a visually understandable manner, for example, there is a method in which according to a level of importance of a plurality of partial images configuring an original image, a reduced image obtained by reducing the original image so that a ratio of a partial image having a higher level of importance is larger is displayed as a result of an image search (see, for example, Japanese Patent Application Laid-open No. 2007-080099).

However, when the user intends to find a desired image from a screen on which the thumbnails are list-displayed, there is a need of devising the display method so that the user can easily grasp contents of the individual thumbnails to give a relationship between the displayed thumbnails to the user in an understandable manner. Accordingly, there has been known a technique in which rather than list-displaying the thumbnail images by simply aligning the same, thumbnail display positions are determined based on attribute value information of the image data and the thumbnail images are arranged like a map within the screen, thereby improving a search efficiency (hereinafter, “image map”). An advantage of this display lies in a point in which the relationship between the images can be visually presented. Particularly, when thumbnail groups having similar properties are collectively arranged on the screen, it becomes possible to easily specify the necessary data group from the displayed image data.

As an image-map method for displaying a thumbnail as an image map, there is known a method in which a feature amount, such as a color, a shape, a size, a type, and a use keyword, is extracted from a display-target image to create a feature-amount vector, and in this state, a self-organization map or the like are utilized to project on a two-dimensional coordinate axis, and an information density is changed to align a plurality of screens in a depth direction thereby moving a viewpoint in a three-dimensional manner, whereby desired data is easily searched (see, for example, Japanese Patent No. 3614235).

Another known image-map method includes that in which an attribute value of each display target is obtained, a center point on a screen is set based on each of the obtained attribute values, from the attribute value of a display-target image, a thumbnail of the image is arranged near the center point, and thereby, the thumbnails of the images having the same attribute values are gathered and displayed (see, for example, Japanese Patent Application Laid-open No. 2005-055743).

Another known image-map method includes that in which a collection of search result images obtained through searching an image database is obtained; an nth dimensional feature amount is extracted from each of the search result images; the nth dimensional feature amount is analyzed by a multivariate statistical analyzing process to calculate a new two-dimensional feature amount; each of the search result images is regarded as a point on a distance space with the two-dimensional feature amounts as two axes thereof and is clustered in m cluster groups; a display position and a display size of each of the search result images are determined based on clustering information obtained therefrom; and each of the search result images is reduced according to the determined display position and display size, thereby the reduced images are list-displayed on a screen of a display apparatus (see, for example, Japanese Patent Application Laid-open No. 2005-235041).

On the other hand, the image map can be utilized also when viewing a database on which still image data photographed by a digital camera or the like are accumulated. Recently a digital video camera having a recording function is widely used, and in this case, the photographed data results in being accumulated and held in the database in a state that besides the still image data, the still image data and moving image data are mixed. Even in a state that the still image data and the moving image data are mixed, when the data is collectively managed, a display method of an image-map format, capable of viewing the entire data in the database and easily recognizing visually a content thereof, becomes necessary.

As a technique in which data objects including a large amount of still and moving image data are efficiently arranged on a screen so that a user himself can easily search with his own eyes, there is a method in which an icon of each data is displayed in a manner to associate with information in a virtual information space that resembles an actual space. According to this method, additional information such as a type of the information, a content thereof, and an importance thereof can be visually given to the user, and an overview of the information and a detail thereof can be viewed while randomly searching through the information space. As a result, an intuitive search becomes possible (see, for example, Japanese Patent No. 3022069).

As a method in which not the still image data but the moving image data, as a target, is arranged and displayed on the image map, there is known a method in which an object thereof is to provide efficient searching and appreciating methods about a large amount of digital broadcast contents, and icons are created from a video content and each icon is arranged and displayed based on a feature amount of the video content (see, for example, Japanese Patent Application Laid-open No. 2001-309269).

As a method in which moving image data, as targets, are arranged and displayed on the image map, there is known a method in which a user selects several items for each moving image data from evaluation axes for arrangement, such as a “generation degree”, a “freshness degree”, and a “popularity by generation”, previously presented by the user himself, and a plurality of moving image data are arranged and displayed in an appropriate position. In this method, a display screen therefor is utilized to provide a display screen for the user to find out a desired moving image at high speed (see, for example, Japanese Patent Application Laid-open No. 2002-314979).

In the invention described in Japanese Patent Application Laid-open No. 2001-309269, an object thereof is to efficiently select a station of a desired program out of a large amount of programs delivered by a digital broadcast, and there is provided means for searching a desired moving-image content from a collection of which the content is restricted to a moving image. However, with respect to data obtained by photographing by a digital camera or the like, still image data and moving image data are mixed and accumulated, and thus, when a user views the entire accumulated data, periodically sorts out the same, or analyzes a content of the same, it is desired that the data can be list-displayed irrespective of the still image and the moving image and groupings are formed and displayed for each visual characteristic.

In the invention described in Japanese Patent Application Laid-open No. 2002-314979, pieces of information having meanings as evaluation axes for determining the display are assumed, and thus, it is possible to search image data having a certain tendency. However, at a time of searching the image data relying on ambiguous memory, such as image data photographed by a user himself, the user finds it difficult to recognize which evaluation axis to set or in which display position on the display screen the image data is arranged.

### SUMMARY OF THE INVENTION

It is an object of the present invention to at least partially solve the problems in the conventional technology.

According to one aspect of the present invention, there is provided an image displaying apparatus that reduces an image to generate a thumbnail image and displays a list of thumbnail images in a display area. The image displaying apparatus includes an attribute determining unit that determines an attribute of image data of the image; a still-image extracting unit that extracts, when the attribute of the image data is determined as a moving image, a still image from the image data; a feature-amount obtaining unit that obtains a feature amount from image data of the still image extracted from the image data of the moving image and image data of a still image when the attribute of the image data is determined as the still image; an arrangement-position determining unit that determines an arrangement position of the display area based on the feature amount; and a display-image generating unit that generates a thumbnail image by reducing the still image and displays a list of thumbnail images in the display area, based on the arrangement position and the display area.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of an image displaying apparatus according to a first embodiment of the present invention;

FIG. 2 is a flowchart of a process according to the first embodiment;

FIG. 3 is a flowchart of a process according to a second embodiment of the present invention;

FIG. 4 is a flowchart of a process according to a third embodiment of the present invention;

FIG. 5 is a flowchart of a process according to a fourth embodiment of the present invention;

FIG. 6 depicts an image map; and

FIG. 7 is a schematic diagram of displaying the image map according to an enlargement ratio.

### DETAILED DESCRIPTION OF THE PREFERRED EMBODIMENTS

Exemplary embodiments of the present invention will be explained below in detail with reference to the accompanying drawings.

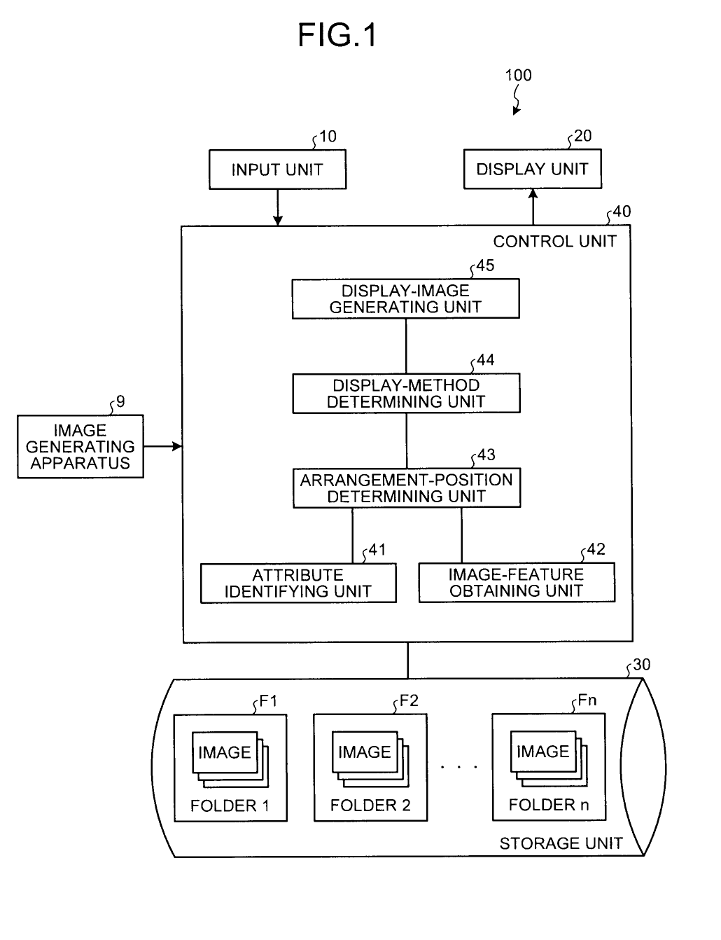

FIG. 1 is a block diagram of an image displaying apparatus according to a first embodiment of the present invention. As shown in FIG. 1, an image displaying apparatus 100 includes an input unit 10, a display unit 20, a storage unit 30, and a control unit 40. In the description below, a moving image and a still image are collectively called an image. Image data includes moving image data and still image data.

The input unit 10 is configured by a pointing device or the like, such as a key board and a mouse, and receives input of a search condition instruction, an addition of the search condition, or input of a change instruction.

The display unit 20 is configured by a liquid crystal display, a CRT or the like, and displays a thumbnail of an image specified according to the search condition, out of an image group, an instruction result in response to an instruction request when receiving it from the input unit 10 or the like.

The storage unit 30 is configured by a hard disk apparatus or the like, and saves, as image data, an image generated by an image generating apparatus 9 such as a digital camera, other photo images, source materials read from a scanner. Particularly, when the image data is configured by a plurality of pages, the image data related to thumbnail data or each page is stored in folders F1 to Fn within the storage unit 30.

The control unit 40 is configured by a central processing unit (CPU) or the like and includes an attribute identifying unit 41, an image-feature obtaining unit 42, an arrangement-position determining unit 43, a display-method determining unit 44, and a display-image generating unit 45. These members are program modules, for example.

The attribute identifying unit 41 analyzes each image data to determine whether the image data is the moving image or the still image, and extracts the still image from the image data of the moving image when the image data is identified as the moving image. An attribute determining unit and a still-image extracting unit in the present invention are configured by the attribute identifying unit 41 or the like.

The image-feature obtaining unit 42 obtains an image-feature amount, such as texture information of each image data and a color histogram information thereof. A classifying result obtained from the attribute identifying unit 41 and the image-feature amount obtained from the image-feature obtaining unit 42 are stored in the storage unit 30 in a manner to correspond to each image data. A feature-amount obtaining unit in the present invention is configured by the image-feature obtaining unit 42 or the like.

The arrangement-position determining unit 43 determines an arrangement position of a display area of the display unit 20, based on each image-feature amount stored in the storage unit 30, when the thumbnail image is arranged. The display area can be all display areas of a screen of the display unit 20 or a part of the display area thereof. An arrangement-position determining unit in the present invention is configured by the arrangement-position determining unit 43 or the like.

The display-method determining unit 44 determines a display method (such as a display position and a reduced display size) of the image data in the display area of the display unit 20 when the thumbnail image is arranged.

The display-image generating unit 45 generates a thumbnail of each image, creates display image data based on the display size of the image data, the display position thereof, the display area thereof or the like, determined by the display-method determining unit 44, and generates an image map. A display-image generating unit in the present invention is configured by the display-method determining unit 44, the display-image generating unit 45 or the like.

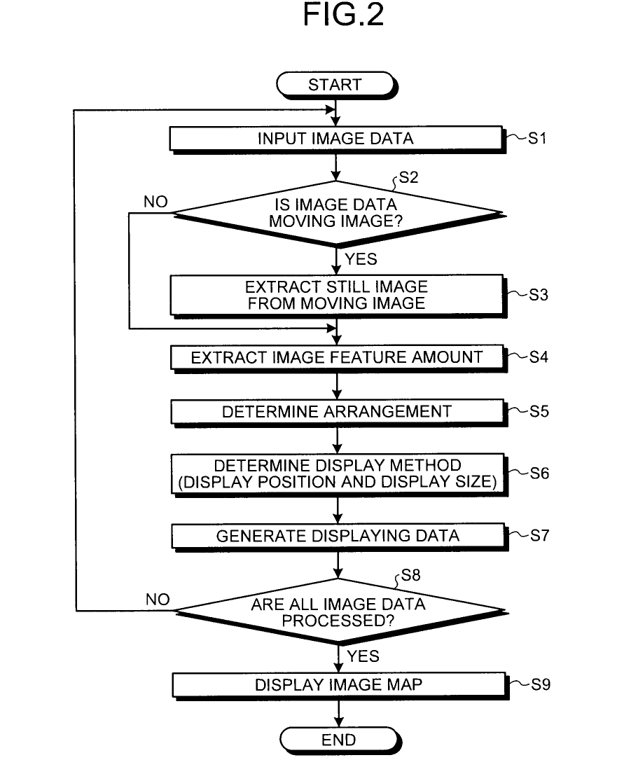

A process of the thus-configured image displaying apparatus according to the first embodiment is described. FIG. 2 is a flowchart showing the process.

First, the image data is inputted to the attribute identifying unit 41 from the input unit 10, the storage unit 30 or the like (Step S1), and whether the image data is the moving image or the still image is determined by the attribute identifying unit 41 (Step S2). When the image data is the moving image, the still image used for displaying the image map is extracted from the moving image by the attribute identifying unit 41 (Step S3). When the image data is determined to be the still image at Step S2, the process advances to Step S4.

When the still image used for displaying the image map is extracted from the moving image, there is a method in which a still image at a previously designated time from a start time is extracted. At this time, there is a need of a special procedure devised to avoid the extraction from a time having a high possibility of including noise data, such as a start time and an end time of the image data of the moving image. The previously designated time can be a time designated by the user.

As another method, a method described in Japanese Patent Application Laid-open No. 2006-060636 can be used so that the attribute identifying unit 41 analyzes noise within the image data of the moving image and extracts the still image based on the analyzed noise amount.

The image-feature obtaining unit 42 extracts the feature amount from the extracted image data of the still image (Step S4). For example, there is a method for extracting a visual feature amount from the image data includes that for creating the image map, in which a feature including at least one of a “color”, a “composition”, and a “texture” that greatly contribute to a broad overview of the image data is extracted from the image data. It can be possible that the image-feature obtaining unit 42 converts the extracted feature amount into a vector to generate a feature vector.

The arrangement-position determining unit 43 determines the arrangement position of a display image based on the feature amount extracted at Step S4 (Step S5). One example of a method for arranging the image data on a two-dimensional or three-dimensional visible space, based on the feature amount, is shown below.

For example, the feature vector is expressed by values corresponding to two or more elements (dimensions) from the elements such as the “color”, the “composition”, and the “texture”. To arrange on a two-dimensional (vertical and horizontal) screen based on a multi-dimensional feature vector extracted at Step S4, the arrangement-position determining unit 43 utilizes a dimension compression method, such as a self-organizing map, to evaluate the display position on the screen of the display unit 20.

A method in which a grouping for each classification of the image data on the two-dimensional or three-dimensional visible space is formed to arrange the image data is described below.

First, the image-feature obtaining unit 42 analyzes the image data to perform classification at Step S4. As a technique for performing classification, there is a technique disclosed in Japanese Patent Application Laid-open No. 2006-39658. According to the technique disclosed in this publication, image data is covered with display areas (windows) of which the size is previously determined to be sufficiently smaller than that of an image, a partial image formed by cutting out a small display area of the image is created from each window, and an order relationship equivalent to a degree of dissimilarity is determined among all the cut-out partial images. Subsequently, based solely on the order relationship, each partial image is mapped onto a point in an arbitrary distance space, and a Cartesian product or a tensor product of a position coordinate vector of the point in the mapped distance space is extracted, as the feature data, by the image-feature obtaining unit 42. The image-feature obtaining unit 42 uses this feature data to perform learning and classification identification relative to a class shown in Table 1, for example. In addition thereto, the image-feature obtaining unit 42 can utilize a learning algorithm such as a support vector machine (SVM), a statistical process or the like, to perform classification into a known class.

Table 1 shows an example of the image data classified and defined up to a second hierarchy. In a first hierarchy, four classes of “people”, “nature”, “art”, and “landscape” are provided. Each class in the first hierarchy is further provided with a definition of the class of the second hierarchy. In the image-map display, a display in which the entire map can be looked at to grasp a broad overview of the entire data is preferable. Accordingly, in defining the class, it is preferable to define the class in a classifiable manner based on a visual condition.

TABLE 1

| First hierarchy | Second hierarchy | Content |
|---|---|---|
| people | event | Those who do |
| | | something |
| | person | Photograph of people |
| nature | animal | Animal |
| | creature | Other creatures |
| | plant | Plant |
| | food | Food |
| Art | vehicle | (Terrestrial) vehicle |
| | aircraft | (Aerial) vehicle |
| | Ship | (Marine) vehicle |
| | structure | Building |
| | Symbol | Symbol |
| landscape | Land | Land |
| | Water | Sea, River |
| | Sky | Sky |

A numerical value, e.g., 1, 2, 3, and 4, is allotted to each of the “people”, “nature”, “art”, “landscape” in the first hierarchy classified as shown in Table 1, and a numerical value, e.g., 1 and 2, is allotted to each of “event” and “person” in the second hierarchy of the first hierarchy. Thereby, a classification result of the image data is converted into a numerical value. The image-feature obtaining unit 42 synthesizes the feature amount obtained by converting the classification result into a numerical value and the image feature amount analyzed from the image data to generate the feature amount vector. Based on the feature amount vector generated at Step S4, the arrangement-position determining unit 43 utilizes the dimension compression method, such as a self-organizing map, to determine the display position for arranging on the screen of the display unit 20.

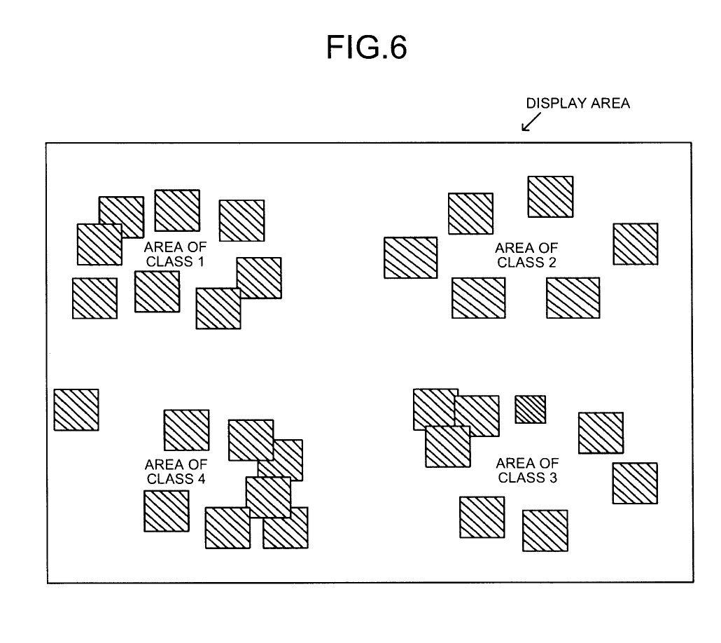

Thus, an arrangement position in which the image data belonging to the same class are arranged close to each other is obtained. FIG. 6 depicts the image map by the arrangement on which the classification is reflected. Shaded portions represent display images. The arranging method in which the class arrangement is reflected is not limited thereto. The class and the arrangement position of the class are determined in advance, and the image data belonging to the class can be arranged near the arrangement position of the appropriate class.

As long as a method for obtaining the arrangement on which the image feature is reflected is available, the method for determining the arrangement is not limited to the method described above.

The display-method determining unit 44 determines the display position of the image data, the reduced display size thereof or the like, based on the arrangement position and the display area determined by the arrangement-position determining unit 43 (Step S6). For example, when a plurality of image data is appropriately arranged in the display area to be list-displayed, as in the image map, it is probable that these image data are displayed in an overlapping manner, and thus, visibility deteriorates. Taking this into consideration, the display-method determining unit 44 can adopt a method in which a vertical-to-horizontal size of the display image is calculated according to the number of image data, the arrangement position is so adjusted that a plurality of display images at a time of calculating the vertical-to-horizontal size are not displayed in an overlapping manner, and in this state, an actual display position is determined, for example.

Another method for determining the arrangement is as follows. When the display-method determining unit 44 displays a large amount of image data in the display area in a non-overlapping manner, it is probable that the vertical-to-horizontal size of each data is restricted to very small. To solve this problem, an upper limit is applied in advance to the number of list-displayed image data, and the user can impart in advance the image data with a level of importance such as display or non-display. In this case, when the number of image data exceeds the upper limit, the display-method determining unit 44 can determine the image data to be displayed and the image data to be non-displayed according to the level of importance.

The display-image generating unit 45 then generates the display image representing the thumbnail based on the display method of the image data (Step S7). The display-image generating unit 45 determines whether all the image data are processed (Step S8). When all the image data are not processed, the process returns to Step S1 to perform the similar process on subsequent input data. When all the image data are processed, the display-image generating unit 45 displays the image map generated from the display image, and then, ends the process (Step S9) At this time, the image map, as shown in FIG. 6, arranged to be grouped for each class is displayed.

In the display image generating process at Step S7, the display image including the image data of the still image and the image data of the moving image is generated. However, when the display image is displayed at Step S9, the image data of the moving image can be reproduced. Although described later, when the image data of the moving image is reproduced, a process for evaluating a reproducing order of the displaying moving image or the like is to be performed at a time of the display (Step S9).

As described above, in the first embodiment, picture (still image) data and video (moving image) data are collectively processed as the image data. Whether the image data is the moving image or the still image is determined, when the image data is identified as the moving image, from the image data of the moving image, the still image is extracted, based on the feature amount obtained by acquiring the feature amount from the image data of the still image, the arrangement position of the display area is determined, based on the arrangement position and the display area, the display images each obtained by reducing the still image are generated, and each of the generated display images is list-displayed in the display area. Thus, it is possible to perform a preferential list-display when a data group including the still image data, and in particular, the moving image data is sorted out, viewed, or analyzed.

It is assumed that a plurality of contents is included within one image data of the moving image. For example, there is a case that the image data of the moving image is divided in advance in a segment unit indicating one event. There is also a case that image data of the moving image at a time of continuously recording a plurality of performances at a live music show or the like is generated. A process in which such cases are taken into consideration is described in a second embodiment of the present invention.

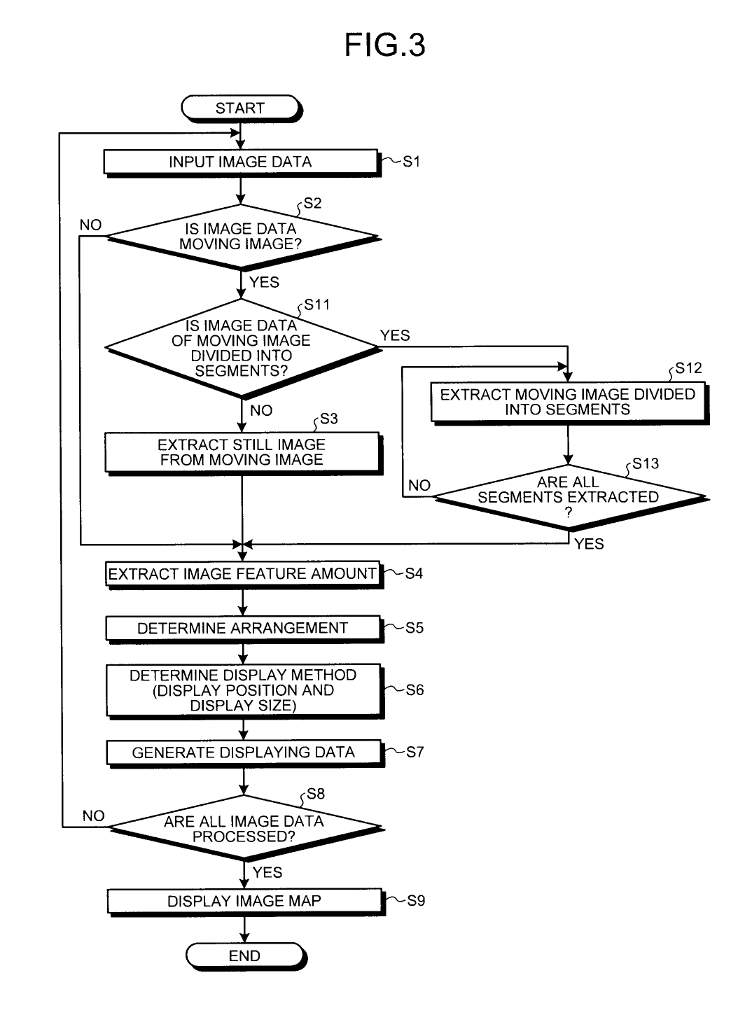

FIG. 3 is a flowchart of a process according to the second embodiment. The flowchart of FIG. 3 is obtained by adding detailed processes around the process at Step S3. In the processes according to the second embodiment, like steps as those in the first embodiment are denoted by like reference numerals.

First, the image data is inputted to the attribute identifying unit 41 (Step S1), the attribute identifying unit 41 determines whether the image data is the moving image (Step S2), and when the image data is the moving image, the attribute identifying unit 41 determines whether the image data of the moving image is divided into segments (Step S11).

When the image data of the moving image is divided into segments, the attribute identifying unit 41 extracts the moving image into a segment unit and extracts the still image into a segment unit (Step S12), determines whether all the segments are extracted (Step S13), and when all the segments are not extracted, the process returns to Step S12. When the image data of the moving image is not divided into segments at Step S11, the still image is extracted from the image data of the moving image.

There is also a method in which the image data of the moving image is analyzed, thereby extracting the still image for each event. When the data is divided into an event unit, i.e., a segment unit, such as a “live performance-first song”, a “live performance-second song”, and a “live performance-third song”, etc., and in this state, the image data is extracted for each of the respective segment units, the image data for each of these segment units results in being arranged and displayed on the image map. Thus, the user becomes able to easily grasp the image data of the moving image from the display screen.

A method in which a video content is analyzed and divided into an event unit is described in Japanese Patent Application Laid-open No. 2005-117330. An apparatus of the invention described in this publication is that in which the video content, together with information such as a video, music, and audio, are analyzed to obtain a cutting point on time of the video content, thereby precisely cutting out a video zone separate by the cutting point. Accordingly, this apparatus can automatically extract a part of the video zone from the video content including the video and the audio.

Further, when a plurality of contents are included in one image data of the moving image, a plurality of image data of the still image are extracted for each event or the like. In this case, it can be desired that the respective image data of the still image are collectively arranged. The arrangement-position determining unit 43 determines the arrangement position of the still image so that the still images, for each segment unit, extracted from one moving image are arranged close to each other, i.e., arranged in one group. In this case, the arrangement-position determining unit 43 selects a representative display image out of the display images of these still images, determines the display position of the representative display image, and arranges and aligns the other display images by organizing the same above or beneath or in the right or the left, etc., of the representative image according to an order of a reproducing time of the image data of the moving image, whereby a plurality of image data included within one image data of the moving image can be arranged close to each other. When the display images are organized according to an order of the reproducing time, it becomes possible to grasp a content of the moving image, thereby contributing to a visibility improvement of the image-map screen.

As described above, in the second embodiment, a case that a plurality of events different in type are included in the image data of the moving image is assumed, and it is desired that the image data that can represent each event can be visually recognized at a time of viewing the data, as in a case that a plurality of performances are continuously photographed in a concert, for example, and when such display images are so arranged in one group to be close to each other, it becomes possible to rapidly search target image data at a time of viewing and streamline data sorting-out.

In the second embodiment, at a time of displaying the image map at Step S9 according to the first embodiment, when the original image data of the display image is the moving image, the display image is reproduced. In a third embodiment of the present invention, a mode in which the image data of the moving image reproduced at one time in each class is limited to one is mainly described. Each display image displayed at Step S9 is in a state of being displayed in a reduced image for the thumbnail, on the image map. When the moving image is reproduced, each display image is reproduced at a display position and in a display size of the display image, based on the original moving image.

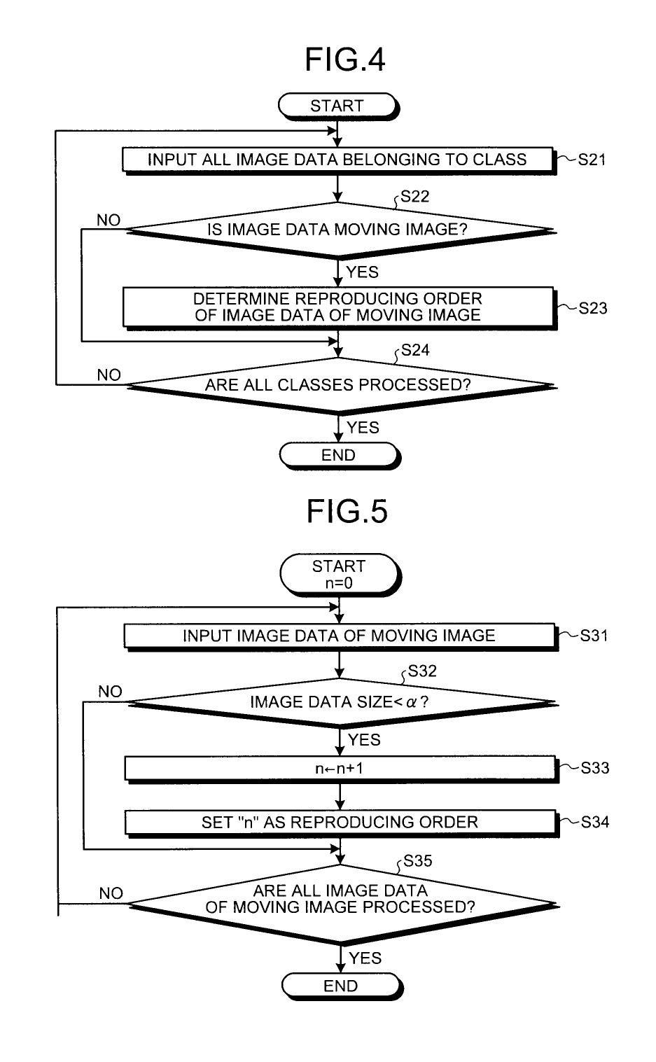

In the third embodiment, a method in which as one example, when the image data are arranged by forming a grouping for each class, a reproducing order of the image data of the moving image within each class is determined is described with reference to drawings. FIG. 4 is a flowchart showing a process according to the third embodiment.

First, the image data belonging to one class is inputted to the display-image generating unit 45 (Step S21). The display-image generating unit 45 determines whether there exists the image data of the moving image for the image data belonging to the class inputted at Step S21 (Step S22). When there exits no image data of the moving image, the process returns to Step S21.

When there exists the image data of the moving image, the display-image generating unit 45 determines the reproducing order of the image data of the moving image (Step S23). For example, the reproducing order is determined in order of a latest date-and-time of creation. Thus, at Step S23, when the displayed image data is configured by a plurality of events, the reproducing order can be so determined that the image data are reproduced in an order of being recorded.

It is determined whether the processes are ended in all the classes (Step S24), and when the processes are ended in all the classes, the process is ended and the display image is reproduced according to the reproducing order.

It is assumed that, when the image data of the moving image is reproduced at a time of displaying the image map, if reproduction of a plurality of moving images is simultaneously started, the user cannot know which image data he or she should notice. However, as described above, in the third embodiment, it is possible to avoid a problem that the user cannot know which image data he or she should notice because the number of image data of the moving image reproduced at one time in each class is limited to one.

The reproduction of the display image having an attribute of the moving image on the image map has an advantage of being able to view a content of the moving image. However, simultaneously viewing the moving images is difficult for the user, and thus, when the user wishes to confirm the moving image one image by one image, it can be probable that a simultaneous reproduction of the moving images interferes a sense of vision. To avoid this interference, the reproducing order of each image data of the moving image can be so determined that only one moving image is reproduced on the screen of the display unit 20. In this case, the reproducing order can be so arranged that the reproduction is started from an image on an upper left of the screen to an image on a lower right thereof. It can be also possible to provide ordering for each class, and the moving image belonging to each class is reproduced one image by one image. Thus, when the moving images on the image map are reproduced not simultaneously, it becomes possible for the user to intensively view one moving-image thumbnail.

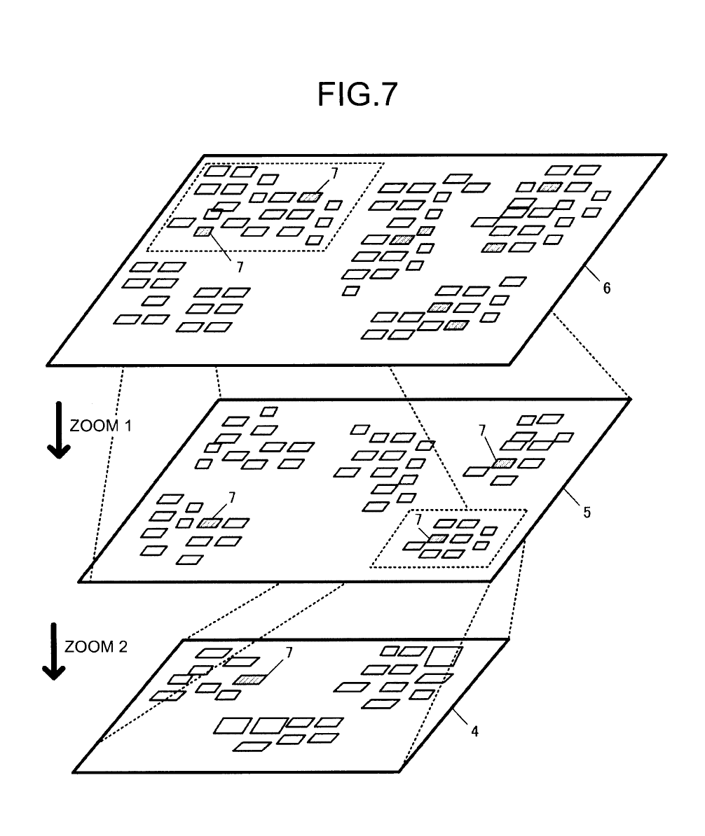

As shown in FIG. 7, the display-image generating unit 45 exhibits a list display of the display images obtained by reducing the image data of the still image, in a partially enlarged (zoomed) manner, and at a time of exhibiting the enlarged list display, when there is a display image 7 extracted by the attribute identifying unit 41 from the moving image out of the display images within the list display, the display-image generating unit 45 reproduces the display image 7 based on the original moving image. The display image 7 is that which is extracted from the moving image by the attribute identifying unit 41. A portion obtained by enlarging (zoom 1) one portion of a display area 6 on an upper stage in FIG. 7 is a display area 5 on a middle stage. A portion obtained by further enlarging (zoom 2) one portion of the display area 5 on the middle stage is a display area 4 on a lower stage.

The display-image generating unit 45 can display the image map, as one piece of image, on an entire display area instead of generating the display images 7 to be list-displayed on the display area. For example, based on the arrangement position and the display area of the plurality of image data determined by the arrangement-position determining unit 43, the display-image generating unit 45 generates an entire-display image for display images each obtained by reducing the still images in the entire display area, together with displaying the entire-display image on the display area. When the entire-display image includes an image obtained by reducing the still image extracted from the moving image, the image is reproduced based on the original moving image.

In the third embodiment, when only one moving image is reproduced on the screen of the display unit 20, the reproducing order is determined in the image data of the moving image which is a target to reproduce. Thereafter, in a fourth embodiment of the present invention, image data of the moving image to be reproduced, having a data size equal to or more than a certain threshold value, is controlled not to be reproduced, and in addition, the display is performed by ordering so that two or more image data of the moving image are not simultaneously reproduced. This process is described with reference to a flowchart in FIG. 5.

First, a reproducing-order variable n representing the reproducing order is set to 0 as an initial value. The image data of the moving image, which is a target to reproduce, is inputted to the display-image generating unit 45 (Step S31). The display-image generating unit 45 determines whether a size of the inputted image data is smaller than a previously-determined threshold value α (Step S32).

When the size is not smaller than the threshold value α, the process advances to Step S35, and when the size is smaller than the threshold value α, the display-image generating unit 45 increments the reproducing-order variable “n” by one (Step S33), and uses the determined reproducing order of the image data as the incremented reproducing-order variable “n” (Step S34).

It is determined whether processes about all the image data of the moving image are ended (Step S35), and when the processes about all the image data of the moving image are ended, the process is ended.

As described above, in the fourth embodiment, when the size of the moving image is large, a load of the CPU increases, resulting in a factor causing a slow display operation. Thus, a restriction in which the image data having a large moving-image size is not reproduced is applied, enabling an image-map display that does not apply to the user stress resulting from the slow display operation of the moving image.

As described above, according to one aspect of the present invention, it is possible to perform a list display preferable at a time of sorting out, viewing, or analyzing still image data, in particular, and a data group including moving image data.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image displaying apparatus that reduces an image to generate a thumbnail image, and displays a list of thumbnail images in a display area, the image displaying apparatus comprising:
an attribute determining unit that determines an attribute of image data of the image;
a still-image extracting unit that extracts, when the attribute of the image data is determined as a moving image, a still image from the image data;
a feature-amount obtaining unit that obtains a feature amount from image data of the still image extracted from the image data of the moving image and image data of a still image when the attribute of the image data is determined as the still image;
an arrangement-position determining unit that determines an arrangement position of the display area based on the feature amount; and
a thumbnail-image generating unit that generates a thumbnail image by reducing the still image and displays a list of thumbnail images in the display area, based on the arrangement position and the display area.

2. The image displaying apparatus according to claim 1, wherein when the image data of the moving image includes a plurality of contents,
the still-image extracting unit divides the image data of the moving image into a plurality of image data in units of event or segment and extracts still images from divided image data, and
the arrangement-position determining unit determines arrangement positions of the still images such that the still images are arranged close to each other.

3. The image displaying apparatus according to claim 2, wherein the arrangement determining unit determines the arrangement positions of the still images such that the still images are arranged close to each other in order of reproducing time.

4. The image displaying apparatus according to claim 1, wherein when the still image is extracted from the moving image by the still-image extracting unit, the thumbnail-image generating unit reproduces the thumbnail image based on the moving image when displaying the list of thumbnail images in the display area.

5. The image displaying apparatus according to claim 4, wherein
the thumbnail-image generating unit displays the list of thumbnail images in a partially enlarged manner, and
when the still image is extracted from the moving image by the still-image extracting unit, the thumbnail-image generating unit reproduces the thumbnail image based on the moving image when displaying the list of thumbnail images in a partially enlarged manner.

6. The image displaying apparatus according to claim 4, wherein when the image data of the moving image includes a plurality of contents,
the still-image extracting unit divides the image data of the moving image into a plurality of image data in units of event or segment and extracts still images from divided image data, and
when the still images of the thumbnail images are extracted from a single moving image by the still-image extracting unit, the thumbnail-image generating unit reproduces the thumbnail images based on the moving image in a recording order in the image data of the moving image when displaying the list of thumbnail images in the display area.

7. The image displaying apparatus according to claim 4, wherein the thumbnail-image generating unit reproduces the thumbnail images in the display area one by one.

8. The image displaying apparatus according to claim 4, wherein
a plurality of classes for classifying the image data is set,
the arrangement-position determining unit determines the arrangement position near a position corresponding to an appropriate one of the classes, based on the feature amount, and
the thumbnail-image generating unit reproduces the thumbnail images classified into the classes one by one in each of the classes.

9. The image displaying apparatus according to claim 7, wherein when a size of the image data of the moving image is equal to or larger than a predetermined size, the thumbnail-image generating unit does not reproduce the thumbnail image corresponding to the image data of the moving image.

10. The image displaying apparatus according to claim 8, wherein when a size of the image data of the moving image is equal to or larger than a predetermined size, the thumbnail-image generating unit does not reproduce the thumbnail image corresponding to the image data of the moving image.

11. The image displaying apparatus according to claim 1, wherein instead of generating the thumbnail image and displaying the list of thumbnail images in the display area, the display-image generating unit generates an entire thumbnail image for displaying thumbnail images of the still images in an entire display area and displays the entire thumbnail image in the display area, based on the arrangement position and the display area.

12. A method of reducing an image to generate a thumbnail image and displaying a list of thumbnail images in a display area, the method comprising:
determining an attribute of image data of the image;
extracting, when the attribute of the image data is determined as a moving image, a still image from the image data;
obtaining a feature amount from image data of the still image extracted from the image data of the moving image and image data of a still image when the attribute of the image data is determined as the still image;
determining an arrangement position of the display area based on the feature amount;
generating a thumbnail image by reducing the still image; and
displaying a list of thumbnail images in the display area, based on the arrangement position and the display area.

13. An image displaying system comprising:
an image displaying apparatus that reduces an image to generate a thumbnail image and displays a list of thumbnail images in a display area; and
an image generating apparatus that generates image data from the image, wherein
the image displaying apparatus includes
an attribute determining unit that determines an attribute of image data of the image,
a still-image extracting unit that extracts, when the attribute of the image data is determined as a moving image, a still image from the image data,
a feature-amount obtaining unit that obtains a feature amount from image data of the still image extracted from the image data of the moving image and image data of a still image when the attribute of the image data is determined as the still image,
an arrangement-position determining unit that determines an arrangement position of the display area based on the feature amount, and
a thumbnail-image generating unit that generates a thumbnail image by reducing the still image and displays a list of thumbnail images in the display area, based on the arrangement position and the display area.
